(19) United States
(12) Patent Application Publication
(10) Pub. No.: US 2007/0143779 A1
(43) Pub. Date: Jun. 21, 2007

(54) Location info-based automatic setup of broadcast receiver devices

(76) Inventors: Kari Kaarela, Oulu (FI); Jukka Parkkinen, Oulu (FI); Heikki Korkeamaki, Oulu (FI); Kirmo Koistinen, Oulu (FI)

Correspondence Address: MORGAN & FINNEGAN, LLP, 3 World Financial Center, New York, NY, 10281-2101, US

(21) Appl. No.: 11/311,476

(22) Filed: Dec. 20, 2005

(51) Int. Cl. H04N 7/16

(52) U.S. Cl. 725/25

(57) ABSTRACT

An apparatus, system, method and computer product and medium are provided to implement transmission of information indicating at least a location of a user device; and reception of a broadcast in a selected region from a plurality of broadcast regions in response to the transmitted information. The broadcast includes personalized service for the user of the user device.

### FIELD OF THE INVENTION

The present invention relates to broadcast services. More particularly, the present invention relates to improving user control and service features over broadcast services accessible through mobile devices.

### BACKGROUND

As companies seek to build and expand wireless service offerings, various communication technologies and platforms, such as broadcasting via FM radio, are being utilized to offer services. For example, Microsoft has developed a FM sub carrier technology, generally referred to as Smart Personal Object Technology (SPOT), which is now used for sending limited amount of data into receiver devices. Using this technology, Microsoft offers a web service MSN Direct which allows a user to configure and receive various content, including for example, news, stock information, weather forecasts, time, and other small data objects. Personal data (e.g., messages, calendar info) can also be sent through this service. The user then receives the service, e.g., content and/or personal data, on a receiver device, such as a watch with SPOT capability.

These SPOT receiver devices, however, are one-way receivers. In order to configure the data to be transmitted to a user's SPOT receiver device, the user must access and log on to the MSN Direct web service and configure settings through a separate computer or system with network capabilities and an existing access to the network. Further, the user must manually set or configure services to use whenever the user plans to change a geographical position or location (i.e., travels to another location). In other words, the user must know in advance the location and manually configure services through the MSN Direct web service to receive services at such a location, e.g., not the home location. No configuration can be performed using the current SPOT receiver devices.

### SUMMARY

In accordance with an embodiment, an apparatus, system, method and computer product and medium is provided in which a user device transmits information indicating at least a location of a user device; and receives a broadcast in a selected region from a plurality of broadcast regions in response to the transmitted information. The broadcast includes personalized service for the user of the user device.

The personalized service may be updated through periodic broadcasts. The transmitting operation may include sending the information in a message. The transmitting operation and the receiving operation may be performed by the user device across different communication channels.

Further, the information indicating at least a location of the user device may be transmitted from another communications-enabled device of the user. The user device may transmit the information through another communications-enabled device of the user. The user device may be a Smart Personal Object Technology (SPOT) device, such as a SPOT watch, and the other communications-enabled device may be a mobile phone.

In various aspects, the broadcast may be an FM radio broadcast or Digital Video Broadcasting-Handheld (DVB-H) or other broadcast technology. The personalized service may be provided through Smart Personal Object Technology (SPOT) or other FM radio subcarrier such as Data Radio Channel (DARC) or System for Wireless Infotainment Forwarding and Teledistribution (SWIFT). The personalized service may include personal data of the user, and the personal data may be encrypted and subsequently decrypted for access by the user. The personalized service may also include content.

In another aspect, the apparatus, system, method and computer product and medium further implements determining whether personalized service is available to the user device at a current location, wherein the information indicating at least a location of the user device is transmitted if personalized service is unavailable to the user device at the current location. The determining operation may include ascertaining whether the user device is registered to receive personalized service at the current location, or ascertaining whether personalized service is being received across one or more broadcast channels.

In a further aspect, the apparatus, system, method and computer product and medium further implements transmitting from the user device information for configuring the personalized service for the user.

In another aspect, access is provided to the personalized service on the user device.

In yet a further aspect, a cell identifier of the nearest base station to the user device is obtained, wherein the information indicating at least a location of the user device comprises at least the obtained cell identifier. Alternatively, a position of the user device through GPS is obtained, wherein the information indicating at least a location of the user device comprises at least the obtained position.

In accordance with another embodiment, a broadcast system, method and computer product and medium are provided which involve receiving information transmitted from a user device of a user indicating a location of the user device; and controlling broadcasting of personalized service for the user at a selected region from a plurality of broadcast regions according to the received information.

In accordance with a further embodiment, an apparatus, system, method and computer product and medium are provided which implement or facilitate implementation of the following operations: obtaining information indicating a location of a user device of a user, the information corresponding to a location of a network component of a communications network through which the user device conducts communications; and transmitting or controlling transmission of the information to a broadcast system so that personalized service is broadcasted in a selected region from a plurality of broadcast regions to the user based on the information. The apparatus or system performing such operations may be the user device or a component of the communications network. The information of the user device may correspond to the location of a base station or access point (e.g., hot spots).

### BRIEF DESCRIPTION OF THE DRAWINGS

In the drawings, like reference numbers generally indicate identical, functionally similar, and/or structurally similar elements. The drawing in which an element first appears is indicated by the leftmost digit(s) in the reference number. The present invention will be described with reference to the accompanying drawings, wherein:

FIG. 1 is a block diagram of an exemplary operational environment in accordance with an embodiment;

FIG. 2 is a block diagram of components of an exemplary user device in accordance with an embodiment;

FIG. 3 is a block diagram of components of an exemplary network (or web) server of a service operator in accordance with an embodiment;

FIG. 4 is a block diagram of components of an exemplary broadcast server of a service operator in accordance with an embodiment;

FIG. 5 is a diagram showing an exemplary communication flow between the user device and the broadcast system operated by a service operator in accordance with an embodiment;

FIG. 6 is a flow diagram of an exemplary process implemented by a user device in accordance with an embodiment;

FIG. 7 is a flow diagram of an exemplary process implemented by a network (or web) server of a service operator in accordance with an embodiment;

FIG. 8 is a flow diagram of an exemplary process implemented by a broadcast server of a service operator in accordance with an embodiment;

FIG. 9 is a block diagram of an exemplary operational environment in accordance with a further embodiment;

FIG. 10 is a block diagram of an exemplary operational environment in accordance with another embodiment; and

FIG. 11 is a flow diagram of an exemplary process implemented by a communications network system or its components in accordance with an embodiment.

### DETAILED DESCRIPTION OF THE VARIOUS EMBODIMENTS

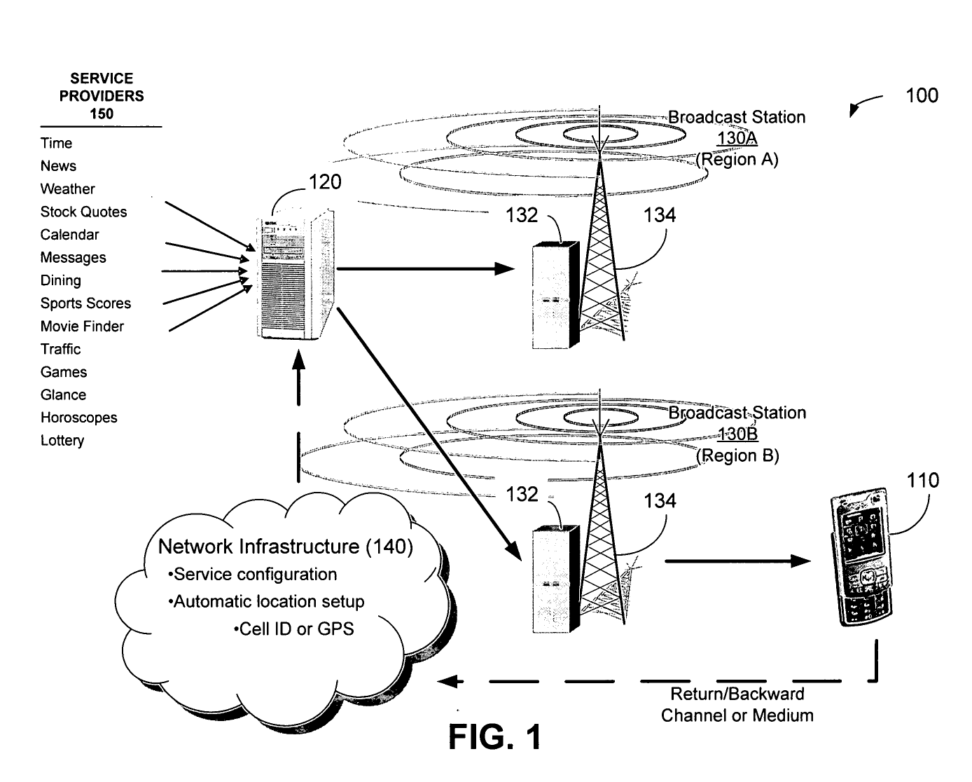

FIG. 1 is a block diagram of an exemplary network environment 100 in accordance with an embodiment. The network environment 100 includes a network server(s) 120, a plurality of broadcast stations 130A, 130B arranged to broadcast services to one or more users in respective regions A and B, user device 110, network infrastructure 140 and service provider(s) 150. Each broadcast station 130A, 130B includes a broadcast server 132 and an antenna 134. The network infrastructure 140 may include one or more networks including wireless or cellular networks and network components such as gateways, access points. The network infrastructure 140 allows communications or transmission of information from the user device 110 to the network server 120, broadcast server 132 or other broadcast system components of a service operator.

As shown, the network server 120 has access to various service offerings from service provider(s) 150. By way of example, the service offerings may include Time/Date, News, Weather, Stock Quotes, Calendar, Messages, Dining, Sports Scores, Movie Finder, Traffic, Games, Glance, Horoscope, Lottery and so forth. The network server 120 in combination with the broadcast stations 130A, 130B may selectively broadcast personalized service for a user in a desired broadcast region. The broadcast may be performed by FM radio, DVB-H or other broadcasting technology.

The personalized service may take the form of customized or configured service offerings (or services), which may include content such a third party content (e.g., news) or user's personal data (e.g., message or calendar), or executable files (e.g., games) and so forth, available through the service provider(s) 150. The service offerings may be customized for each user according to user configuration and/or a location of the user/user device 110 and/or other user-related factors. The user may configure what service offerings are to be provided to the user and/or where, when and/or how services are to be provided to the user. For example, the user may want to receive personal data such as personal messages or calendar and/or sports scores for a particular sport's team or game and/or dining information based on the user's location and/or Time/Date based on the user's location, and/or so forth. The user may register and configure user service settings or preferences for receipt of personalized service by accessing the network server 120 through the Internet via a web site or web service. In this case, the network server 120 may be a web server or the like or work in combination with a web server. Registration and configuration may also be performed through more tradition avenues, such as through a service representative of the service operator.

The network server 120 may package or generate for each user personalized service data which customizes services offerings according to the user configuration, may encrypt such personalized service data such as using the user device ID or other user unique information, and may then route the personalized service data to an appropriate broadcast station 130A or 130B for broadcast of personalized service to one or more users. The broadcast server 132 receiving the routed personalized service data for a user may then broadcast such data to provide personalized service to the user in the selected broadcast region. These personalized service may be periodically updated and broadcasted, and may be received and accessed by the user via the user device 110.

The user device 110 may be a mobile device such as a cellular phone, wireless personal digital assistant (PDA), or any device which may be configured to receive broadcast services, such as a SPOT receiver device. The user device 110 also includes transmission capability, such as the ability to transmit or communicate, for example, through a return/backward channel or medium or communications. In this way, the user device 110 is able to transmit or send to the service operator or its broadcast system information pertaining to the provision of services to the user across the network infrastructure 140.

This information may for example include location-type information of the user or user device, other user configuration data and so forth. The user device 110 may obtain location-type information such as a global positioning satellite (GPS) position of the device from a GPS system, or such as a cell Identifier (ID) of the nearest base station from a cellular network or an identifier of nearest wireless access point (e.g., hot spots) through a wireless local area network (W-LAN) accessible by the user device 110, via appropriate application program interface (API). The user device 110 may obtain location-type information through any other available means.

The return/backward channel or medium or communications may be a messaging/communication system, from one of the following examples:

(1) Short Message Service (SMS). This service is available many digital mobile phones and permits the sending of short messages (e.g., text messages) between mobile phones, other handheld devices and even landline telephones. The Short Message Service-Point to Point (SMS-PP) is defined in Global System for Mobile Communications (GSM) recommendation 03.40. This is separate from GSM 03.41 which defines the Short Message Service-Cell Broadcast (SMS-CB) which allows messages to be broadcast to all mobile users in a specified geographical area. Messages are sent via a store-and-forward mechanism to a Short Message Service Centre (SMSC), which will attempt to send the message to the recipient and possibly retry if the user is not reachable at a given moment.

(2) Multimedia Messaging System (MMS). This system transmits not only text messages, but also various kinds of multimedia contents (e.g. images, audio &/or video clips) over wireless networks using the Wireless Application Protocol (WAP) protocol. MMS has been designed to work with mobile packet data services such as General Packet Radio Service (GPRS) and 3G. The MMS data flow starts with a subscriber using an MMS client on the mobile phone to compose, address, and send an MMS message to one or more recipients. MMS addresses can be either E.164 phone numbers or RFC 2822 e-mail addresses. The initial submission by an MMS client to the home MMS Center (MMSC) is accomplished using HTTP with specialized commands and encodings (which are defined in a technical standard specified by the Open Mobile Alliance). Upon reception of the MMS message, the recipient MMSC (MMS Center) sends a notification to the recipient's mobile phone using either an SMS notification, HTTP Push or WAP Push. There are two modes of delivery in MMS: immediate or deferred.

(3) Electronic mail (email). Email is a method of composing, sending, and receiving messages over electronic communication systems. The term email may apply to the Internet email system based on the Simple Mail Transfer Protocol (SMTP). Email may also apply to workgroup collaboration systems, which allow users within one company or organization to send messages to each other through non-standard protocols but using some form of gateway to allow them to send and receive Internet email.

(4) GPRS data channel. GPRS is a mobile data service available to users of GSM mobile phones and is often referred to as 2.5G. GPRS provides moderate speed data transfer, by using unused TDMA channels in the GSM network. GPRS is integrated into GSM standards releases starting with Release 97 and onwards. First GPRS was standardized by European Telecommunications Standards Institute (ETSI) but now that effort has been handed onto the 3GPP.

(5) Universal Mobile Telecommunications System (UMTS) data channel. UMTS is one of the third-generation (3G) mobile phone technologies. UMTS uses W-CDMA as the underlying standard, is standardized by the 3GPP, and represents the European/Japanese answer to the ITU IMT-2000 requirements for 3G Cellular radio systems.

The above are simply a few examples by which a return/backward channel or communications may be implemented to transmit information from the user device 110. Other communication systems or approaches, e.g., Bluetooth, etc., may be employed or incorporated into the network environment 100 to enable transmission of information from the user device 110 and receipt of such information by the broadcast system of the service operator (e.g., network server 120, broadcast server 132, etc.).

By incorporating a transmission capability into a broadcast service receiving device, the user device 110 may automatically or dynamically or on the fly set up and receive personalized service as the user travels or moves, for example, to a broadcast region in which service is currently unavailable or needs to be configured or set up for the user.

The above feature may be applied for example to Microsoft's MSN Direct web service. For instance, the network environment 100 may implement Microsoft's SPOT service or technology, the like using FM sub-carrier channels, through the web service MSN Direct or the like. However, the mobile SPOT receiver devices (e.g., user device 10) are configured to include an FM radio receiver (e.g., DirectBand radio receiver) and a transmitter or transceiver to transmit location-type information, other user configuration information or any other information pertaining to the provision of personalized service via FM radio broadcast. The broadcast system (e.g., network server(s) 120 and broadcast server(s) 132) receives and handles information transmitted from the SPOT receiver device and broadcasts personalized service to the user according to the received information.

In this SPOT example, the user device may be adapted to obtain location-type information such as from GPS or cell identifier of the nearest base station or identifier of the nearest access point (e.g., hot spots), via location API, and to send the location-type information to the SPOT broadcast system using a desired messaging/communication method, such as noted above. The SPOT-enabled network (or web) server is adapted to handle or recognize the location-type information message(s) sent by one or more SPOT devices, to configure personalized service to be broadcasted to one or more users based on their geographical location, to determine an appropriate or particular broadcast region from a plurality of broadcast regions or broadcast station/broadcast server from a plurality of broadcast stations/broadcast servers, and to route personalized service data for each user to an appropriate determined broadcast station/broadcast server for broadcast. As noted above, the personalized service or personalized service data to be broadcasted may be configured according to the geographical location or position of the user device as well as other factors such as other user configuration or preference data. Accordingly, the transmission feature improves the usability of SPOT devices and services and adds value to mobile phones or other devices as SPOT devices.

Although the above describes modification an implementation of Microsoft's MSN Direct service using SPOT technology, the utilization of a return/backward channel, medium or communications may be incorporated into any mobile device and implementation which receives broadcast personalized service. For instance, other FM radio technologies may be used such as or DARC or SWIFT (standardized by ETSI).

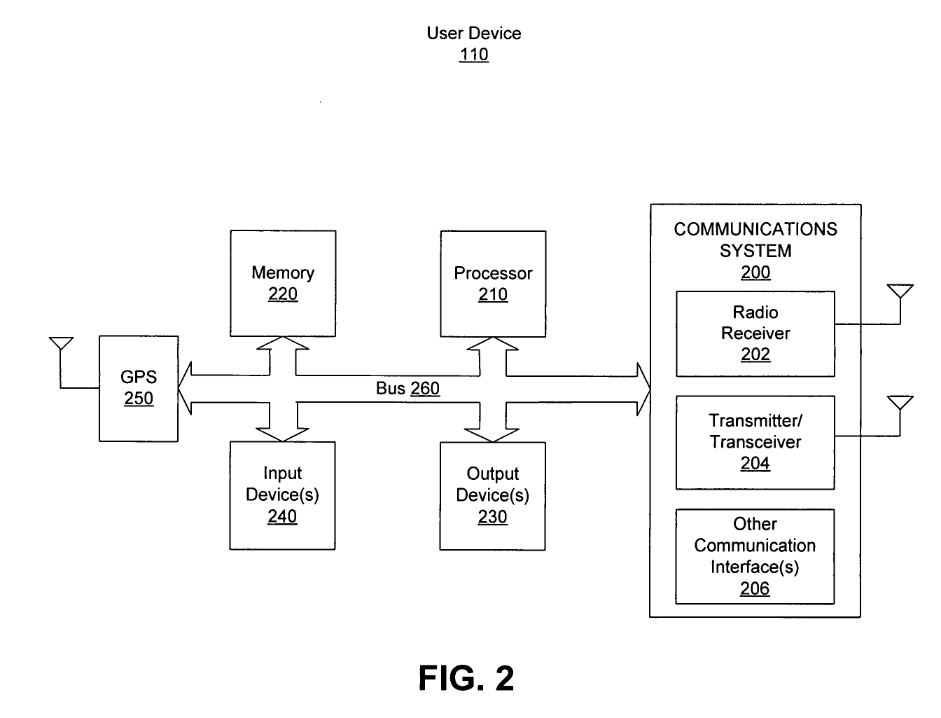

FIG. 2 is a block diagram of components of an exemplary user device 110 in accordance with an embodiment. As shown, the user device 110 may generally include one or more processor(s) 210, a memory 220, input device(s) 240, output device(s) 230, a communications system 200 and GPS system 250, connected across one or more buses 260. In addition, each of these components is coupled to a power source, such as a rechargeable battery (not shown).

The processor(s) 210 control the various operations and functions of the user device, including the information transmission and personalized service access feature described herein. The processor(s) 210 may include one or more microprocessors that are each capable of executing software instructions or computer executable code stored in memory 220.

The memory 220 may include random access memory (RAM), read only memory (ROM), and/or flash memory or other tangible memory medium, and stores information in the form of data and software components (also referred to herein as modules). These software components include instructions or code that can be executed by the processor(s) 210, such as to perform the various features described herein. Various types of software components may be stored in the memory 220. For instance, the memory 220 may store software components that control the operation of components of the user device, such as the communications system 200, input device(s) 240, output device(s) 230 and GPS system 250.

The memory 220 may also store software components that control the operation of transmitting information (e.g., location-type information, user configuration, etc.) to a broadcast system, receiving broadcasted personalized service, decrypting personalized service/personalized service data and allowing the user to access the personalized service.

The input device(s) 240 may include one or more devices that allow a user to input information. Examples of such devices include keypads, touch screens, and microphones. The output device(s) 230 may include various devices, such as a display, and one or more audio speakers. Exemplary displays include liquid crystal displays (LCDs), and video displays. The GPS system 250 provides a GPS position of the user device.

The communication system 200 includes a radio receiver 202, such as an FM radio receiver or DirectBand radio receiver, for receiving data which includes personalized service from one or more broadcast channels or sub-channels. The DirectBand radio receiver is able to receive data from one or more sub-carriers in the range of 58.65 kHz to 76.65 kHz. The communication system 200 also includes transmitter/transceiver 204 to transmit information or data from the user device such as through wireless communications, and other communication interface(s) 206 including serial or parallel or USB connection or network interface or so forth. The communication system 200 may be configured to implement any one of the communications/messaging described above, such as SMS, MMS, email, GPRS/UMTS data channel, etc., as a return/backward channel for transmitting information to the service operator or its broadcast system (e.g., network server 120, broadcast server 132, etc.).

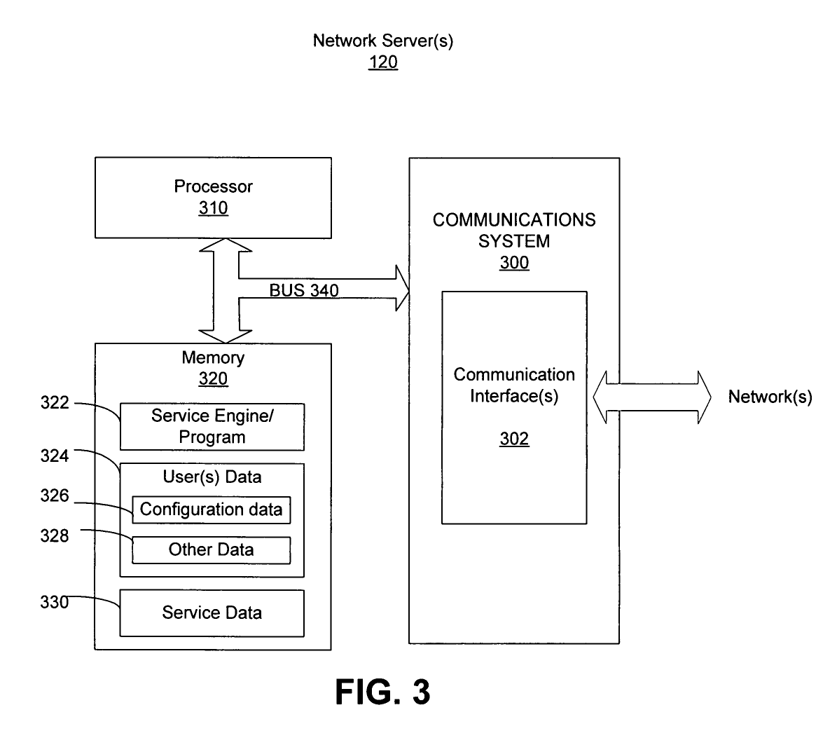

FIG. 3 is a block diagram of components of an exemplary network (or web) server 120 of a service operator in accordance with an embodiment. The network server 120 includes processor(s) 310, communications system 300 and memory 320, which are coupled across one or more buses 340. The communications system 300 includes communication interface(s) 302 such as a network interface and other communications components to enable communications with other parties or entities across one or more networks, such as the Internet, Wide Area Network (WAN), etc.

The processor(s) 310 control the various operations and functions of the network server, including the information receiving and handling, and broadcast features described herein. The processor(s) 310 may include one or more microprocessors that are each capable of executing software instructions or computer executable code stored in memory 320.

The memory 320 may include random access memory (RAM), read only memory (ROM), and/or flash memory or optical drives or hard drives or other tangible memory medium, and stores information in the form of data and software components (also referred to herein as modules). These software components include instructions or code that can be executed by processor(s) 310. Various types of software components may be stored in memory 320. For instance, memory 320 may store software components or an operating system that control the operation of components of the network server 120, such as the communications system 300.

Memory 320 may store software components, such as service engine or program 322, that control the operations for providing broadcast services to one or more users. These operations may for example involve operating a web service or site which may allow a user (or subscriber) to register for the service and to configure service settings for the user, including what service offerings and/or where, when and/or how services are provided. They may also involve coordinating receipt of service offerings (e.g., content, personal data, files, etc.) from service provider(s) (e.g., providers 150) and distributing such service offering to one or more users.

Other operations may also involve (1) monitoring for and receiving information (e.g., location-type information, user configuration, etc.) transmitted from a user device such as the user device 110, (2) determining a broadcast station or broadcast region from a plurality of broadcast stations or broadcast regions according to the received location-type information, (3) configuring personalized service/personalized service data for broadcast according to user configuration and/or location, (4) encrypting personalized service data, and (5) routing personalized service data to the determined broadcast station (or broadcast server) for broadcast. The personalized service may be configured from service data 330 such as service offerings provided from the service provider(s) 150 in FIG. 1. The service data 330 may include third party content and/or the user's personal data such as message or calendar or schedule of the user and/or files such as executable files (e.g., games) and so forth.

The memory 320 may also store user data 324 for a plurality of users (or subscribers). The user data may include user configuration data 326 which may define user service preferences or settings, e.g., what service offerings, and/or where, when or even how services are to be broadcasted to the user. The user configuration data may be updated via the Internet through a web service or site operated by network server 120 and/or through transmission from the user device 110. The user data 324 may also include other data 328, such as user or user device identifiers or the like, user registration information (e.g., name, address, number of devices, subscription type, etc.). As noted above, the user device ID may be used to encrypt or decrypt personalized service data.

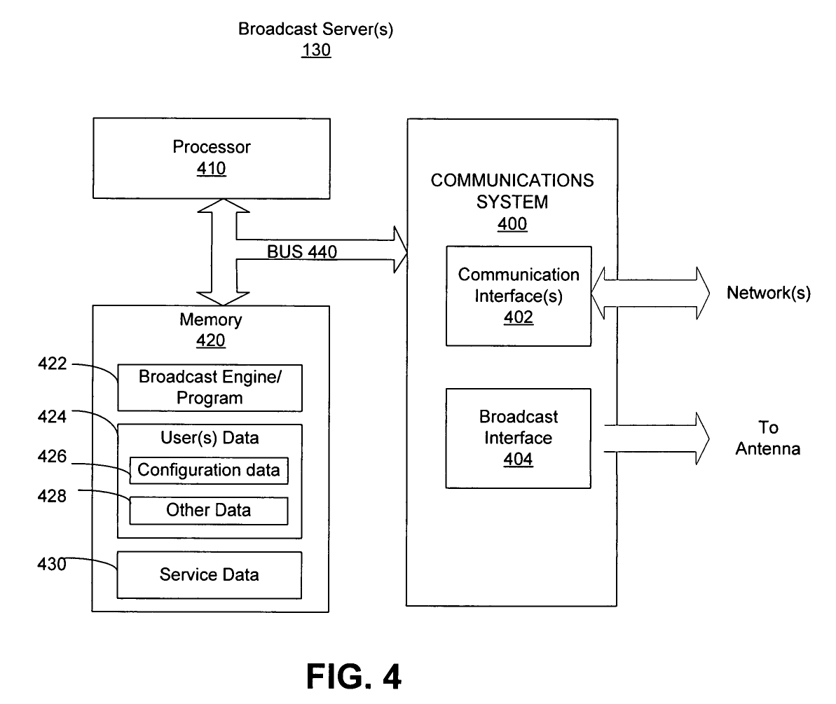

FIG. 4 is a block diagram of components of an exemplary broadcast server 132 of a service operator in accordance with an embodiment. The broadcast server 132 includes processor(s) 410, communications system 400 and memory 420, which are coupled across one or more buses 440. The communications system 400 includes communication interface(s) 402 such as a network interface to enable communications across one or more networks, and broadcast interface/transmitter 404 for broadcasting data from an antenna (e.g., 134) at a respective broadcast station.

The processor(s) 410 control the various operations and functions of the broadcast server, including the information receiving and handling, and broadcast features described herein. The processor(s) 410 may include one or more microprocessors that are each capable of executing software instructions or computer executable code stored in memory 420.

The memory 420 may include random access memory (RAM), read only memory (ROM), and/or flash memory or optical drives or hard drives or other tangible memory medium, and stores information in the form of data and software components (also referred to herein as modules). These software components include instructions or code that can be executed by processor(s) 410. Various types of software components may be stored in memory 420. For instance, memory 420 may store software components or an operating system that control the operation of components of the broadcast server 132, such as the communications system 400.

The memory 420 may store software components, such as broadcast engine or program 422, that control the operations for broadcasting services to one or more users. These operations may for example involve (1) receiving personalized service data for one or more user, (2) placing on a broadcast job queue a job for broadcasting personalized service/personalized service data, and (2) broadcasting the personalized service for receipt by the user. The personalized service for a particular user may be periodically updated and broadcasted. For example, the job queue may be set or configured to transmit the most update personalized service data or the like for a user every two minutes, five minutes, etc., as desired. In this way, a user is provided with continuous or near continuous update, for example in a periodic manner, of personalized service (e.g., most recent content, new messages, etc.).

The above describes one example in which personalized data is configured and routed to the broadcast station 130 for broadcast. Other configurations may also be implemented. For instance, if desired, the memory 420 may also store user data 424 for a plurality of users (or subscribers). Instead of receiving already packaged or generated personalized service data from the network server 120, the network server 120 may transmit the user configuration or route the message from the user device 110 to allow the broadcast server 132 to access service offerings such as stored in service data 430 and to perform the personalization of the services for the user. For example, the services may be personalized and encrypted at the broadcast server 132 rather than at the network server 120. The user data 424 may include user configuration data 426 which may define what service offerings, and/or where, when or even how services are to be broadcasted to the user. The user configuration data 426 may be updated via the Internet through a web service or site operated by network server 120 and/or through transmission from the user device 110. The user data 424 may also include other data 428, such as user or user device identifiers or the like, user registration information (e.g., name, address, number of devices, subscription type, etc.). As noted above, the user device ID may be used to encrypt or decrypt personalized service data.

The above FIGS. 2 through 4 are simply examples of the user device, the network server and the broadcast server and their components. These device and servers may be configured in other manners with different components or component arrangements to perform the various features described herein.

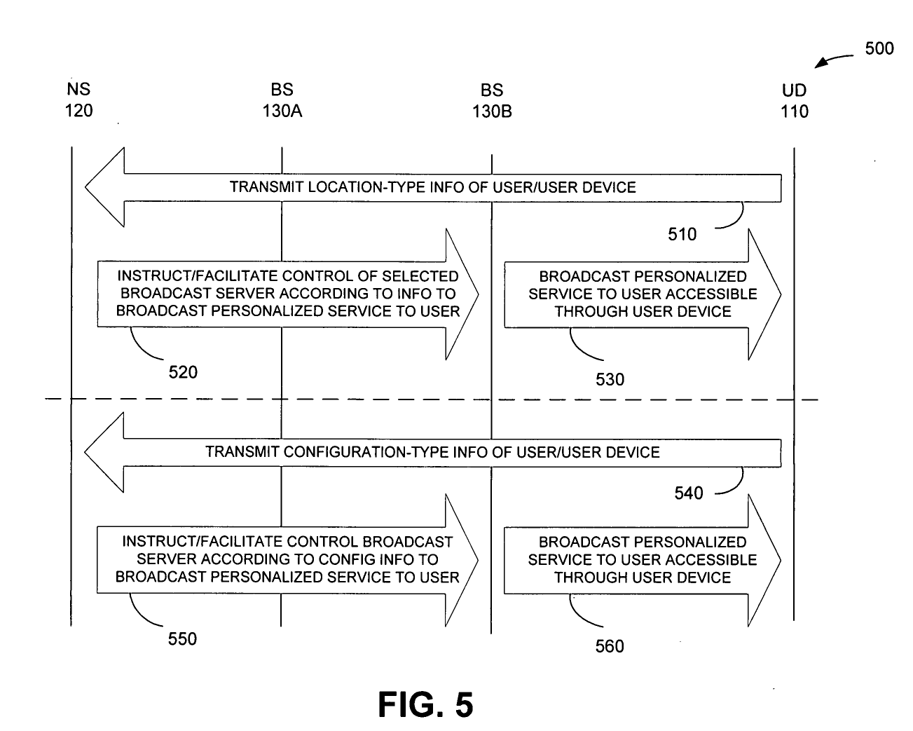

FIG. 5 is a diagram showing an exemplary communication flow 500 between the user device and the broadcast system operated by a service operator in accordance with an embodiment. By way of example, the exemplary communication flow will be described with reference to the network server (NS) 120, broadcast stations (BS) 130A, 130B and user device (UD) 110 of FIG. 1.

In one aspect, the user device 110 transmits location-type information of the user device or user to the network server 120 at step 5 10. The information may be transmitted along with a user or user device identifier. The transmission may be performed automatically by the user device 110 or upon a triggering event or condition. For example, the user device transmits the location-type information when the user device 110 travels to a new or unregistered broadcast service location or a location in which service is currently unavailable or not set up. At step 520, the network server 120 instructs or facilitates control of selected broadcast station (or its broadcast server) according to the received location-type information to broadcast personalized service to the user. For example, if the location-type information reflects that the user or user device 110 is in region B, then in step 520 the broadcast station 130B is instructed or controlled to broadcast personalized service to the user. This may involve transmitting encrypted personalized service data for the user to the broadcast station 130B for broadcasting. The personalized service data may be packaged or generated according to the location of the user/user device and/or user configuration in general. For example, if the user subscribes to dining services, the personalized service data may then include content identifying one or more restaurants in the vicinity of the user/user device. At step 530, the broadcast station 130B broadcasts personalized service to the user, which is received and accessed through the user device 110.

In another communication flow embodiment, the user device 110 transmits user configuration information of the user to the network server 120 at step 540. The information may be transmitted along with a user or user device identifier. The transmission may be initiated manually, automatically or upon a triggering event or condition through the user device 110. The user configuration as noted above may define among other things what service offerings, and/or where, when or even how services are to be broadcasted to the user. At step 550, the network server 120 instructs or facilitates control of selected broadcast station 130B (or its broadcast server) according to the user configuration information to broadcast personalized service to the user. This may involve transmitting encrypted personalized service data for the user to the broadcast station 130B for broadcasting. The personalized service data may be packaged or generated according to at least the user configuration. For example, if the user updates his or her preferences to include traffic service or content, the personalized service data may then include content describing the traffic conditions in the vicinity of the user/user device location. Likewise, the user may update his or her preferences to remove or modify one or more service offerings. At step 560, the broadcast station 130B broadcasts personalized service to the user, which is received and accessed through the user device 110.

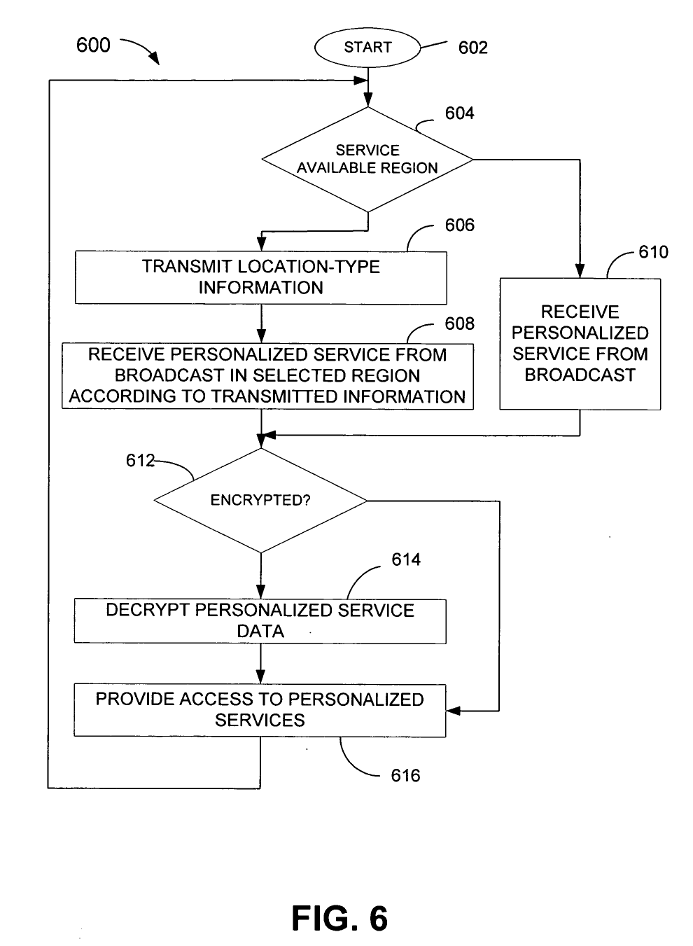

FIG. 6 is a flow diagram of an exemplary process 600 implemented by a user device in accordance with an embodiment. By way of example, the exemplary process 600 will be described below with reference to the user device 110 of FIG. 1. The process 600 begins at step 602, which may involve initialization of system components of the user device 110.

At step 602, the user device 110 determines whether service is available in the current location or region. For example, the user device 110 may check for availability of personalized service, e.g., if personalized service data for the user is being broadcasted in the region. This check may continue for a predetermined period, e.g., 5 minutes, the time greater than the interval in which services are broadcast, and so forth. If service has not been received by the predetermined time, then service is current unavailable at the current location. Alternatively, the user device 110 may identify its location and determine if service has been set up in the particular region. This may involve comparing the current location to a list of service registered or set up locations for the user.

If service is unavailable, the user device 110 can be configured to automatically, dynamically or on the fly set up service in the current location or region. For example, at step 606, the user device 110 transmits location-type information (along with user/user device identifier) to the broadcast system (e.g., servers 120 or 132) of the service operator. As noted above, this information may be sent through various communications mediums or formats (e.g., messages). Thereafter, at step 608, the user device 110 receives personal service via broadcast in the selected region according or in response to the transmitted location-type information.

At step 612, the user device 110 determines whether the received personal service or its data is encrypted. If so, the user device 110 decrypts the personalized service data. In any event, at step 616, the user device 110 provides access to the received personalized service. For example, the user can access personalized service, such as messages, news or other content or services.

Turning back to step 604, if service is available then the process 600 proceeds to step 610 at which the user device 110 receives broadcasted personalized service. Thereafter, the process 600 then proceeds through steps 612 through 616 as described above.

Although the above describes an example in which transmission capability may be employed to set up or obtain services in a location or region, other information may also be transmitted from the user device 110 to the broadcast system of the service operation to control provision of services to the user. Other information may include for example other user configuration data, such as user preferences or setting as described herein.

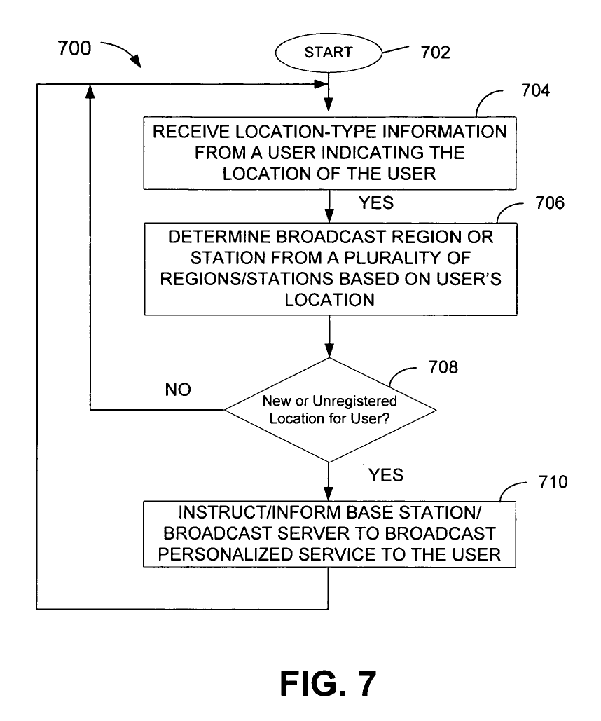

FIG. 7 is a flow diagram of an exemplary process 700 implemented by a network (or web) server of a service operator in accordance with an embodiment. By way of example, the exemplary process 700 will be described below with reference to the network server 120 of FIG. 1. The process 700 begins at step 702, which may involve initialization of system components of the network server 120.

At step 704, the network server 120 receives location-type information from a user indicating the location of the user/user device. At step 704, the network server 120 determines a broadcast region or broadcast station from a plurality of broadcast regions/broadcast stations based on the user/user device's location.

At step 708, the network server 120 determines whether the location is a new or unregistered location for the user, e.g., the broadcast system needs to be set up or configured to provide service to the user at the determined broadcast region or broadcast station corresponding to the user/user device's location. For example, the network server 120 may check whether service is currently available or unavailable to the user at the determined broadcast region or broadcast station. If the location is not a new or unregistered location (e.g., service is available), the process 700 proceeds back to step 704.

Otherwise, if the location is a new or unregistered location for the user, the network server 120 instructs or informs the determined broadcast station or its broadcast server to broadcast personalized service to the user at step 710. The network server 120 may instruct or inform the broadcast server 132 by transmitting personalized service data for the user to the broadcast server for broadcasting. The personalized service data may be periodically updated thereafter and transmitted to the determined broadcast server 132. The network server 120 may terminate any further transmission of personalized service data (e.g., updated data) to the broadcast server 132 of the determined broadcast region/broadcast station when the user/user device's leaves the determined broadcast region. This likewise may be determined based on received location-type information transmitted from the user device 110.

Alternatively, the network server 120 may instruct or inform the broadcast server by forwarding or transmitting the location-type information and/or user configuration data to the broadcast server. In this example, the broadcast server 132 may then generate personalized service data for the user and broadcast personalized data.

In either case, the process 700 may then proceed back to step 704.

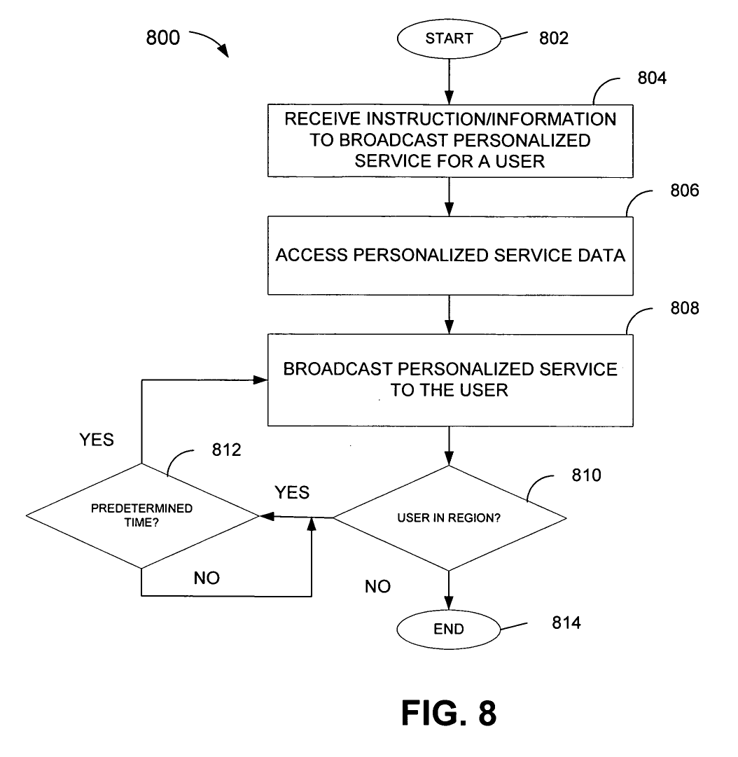

FIG. 8 is a flow diagram of an exemplary process 800 implemented by a broadcast server of a service operator in accordance with an embodiment. By way of example, the exemplary process 800 will be described below with reference to the broadcast server 132 of FIG. 1. The process 800 begins at step 802, which may involve initialization of system components of the broadcast server 132.

At step 804, the broadcast server 132 receives instructions or is informed to broadcast personalized service for a user. At step 806, the broadcast server 132 accesses the personalized service data, which may be obtained from the network server 120 or locally generated based on user configuration and/or location-type information. The broadcast server 132 may then place the task for broadcasting the personalized service on a broadcast job queue. At step 808, the broadcast server 132 causes personalized service to be broadcasted in the region.

At step 810, the broadcast server 132 determines whether the user/user device is still in the region covered by the broadcast server 132. This may be accomplished through additional transmission of location-type information from the user device 110 to the network server 120 and/or broadcast server 132. If the user/user device is no longer in the region covered by the broadcast server 132, then the process 800 ends as to the broadcast of personalized service to the particular user.

Otherwise, if the user/user device is in the region, then the broadcast server 132 determines whether a predetermined time has elapsed. If not, the process 800 continues to check at step 810. Otherwise, if the predetermined time has elapsed, the process 800 proceeds to step 808 in which the broadcast server 132 broadcasts personalized service or updated personalized service. The process 800, as described above, then proceeds to step 808 and so forth.

The above describes processes, such as in FIGS. 5-8, which may be implemented or controlled by software including firmware through one or more processors or one or more hardwired or integrated circuits or a combination thereof. The software implementation may take the form of a tangible medium having computer executable code which when read and executed by one or more processors performs the processes described above and herein. These processes are provided as a few examples. The processes are not limited to the described operations or order of operations which can be modified to perform the various functions described herein.

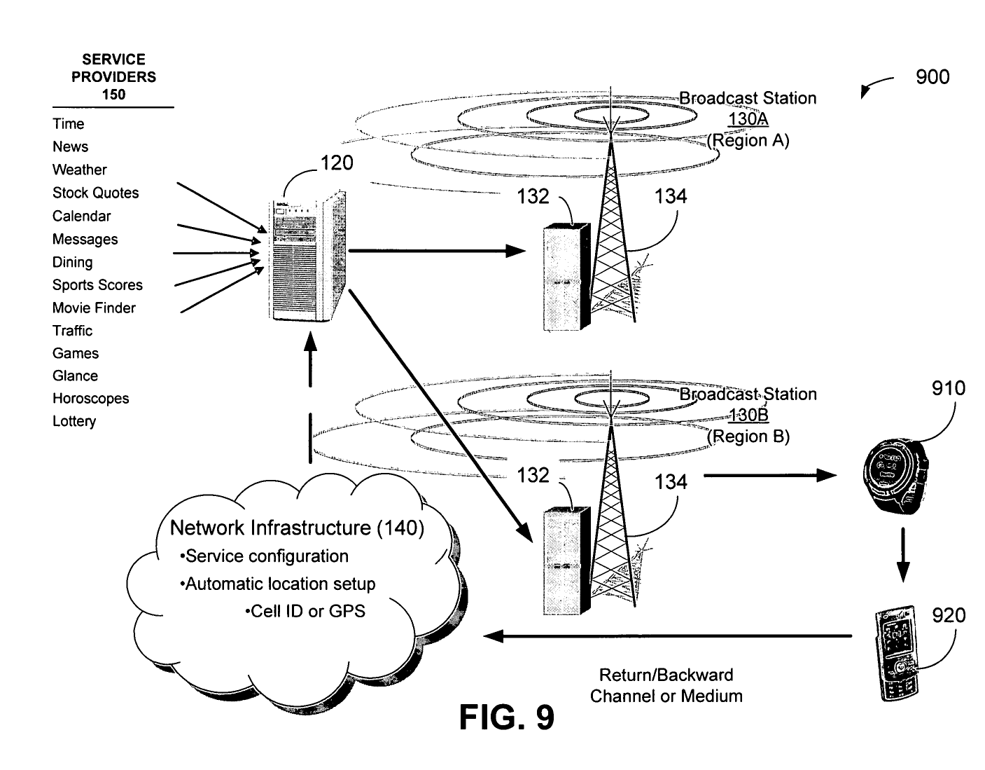

FIG. 9 is a block diagram of an exemplary operational environment 900 in accordance with a further embodiment. The operational environment 900 is generally the same as the operational environment 100 of FIG. 1, except that a first user device 910 (which receives broadcast services) transmits information, such as location-type information or other types as described herein, to the broadcast system of the service operation, through a second user device 920.

The first and second user devices 910 and 920, respectively, may generally include components and be configured in a manner similar to the user device 110 of FIG. 2. For example, both devices 910 and 920 may include a processor(s), memory, communications system and at least one of the devices may include a GPS system or the like. The first and second user devices 910 and 920 are configured to allow communication of information at least from the first user device 910 to the second device 920 or to allow communications therebetween. The devices 910 and 920 may communicate through a short range wireless technology, such as Bluetooth, or other communications technology. The second device 920 may be a mobile or cellular phone, and the first user device 910 may be a SPOT-type watch.

The following is provided as operational examples by which the two devices 910 and 920 cooperate to transmit information, such as location-type information or other information described herein, to the broadcast system (e.g., server 120 or 132) of the service operator.

In an operational example, the first user device 910 obtains location-type information such as position information obtained through a GPS system and transmits the location-type information to the second user device 910 which routes or sends the location-type information to the broadcast system or its components, across the network infrastructure 140. The second user device 910 may transmit or route the location-type information using for example the various communication mediums or formats discussed above, such as SMS, MMS, email, GPRS/UMTS data channel, etc or other suitable communications. As described above, the broadcast system may then broadcast personalized service according to the location-type information or other transmitted information (e.g., other user configuration information). The personalized service may then be received and accessed through the first user device 110.

In another operational example, the first user device 910 causes the second user device 920 to obtain location-type information such as position information obtained through a GPS system or cell identifier of the nearest base station or identifier of the nearest access point (e.g., hot spots) and to transmit this information to the broadcast system or its components, across the network infrastructure 140. The first user device 910 may simply send an instruction or request to the second user device 920 which is configured to obtain and transmit the information to the broadcast system or its components in response to the instruction or request.

The above describes examples by which information pertaining to the provision of broadcast services may be transmitted to the broadcast system or its components through collaboration between a user's broadcast receiver device and another communications-enabled device of the user. The user devices may however be configured to cooperate in other manners than described above to perform the transmission of information to the broadcast system.

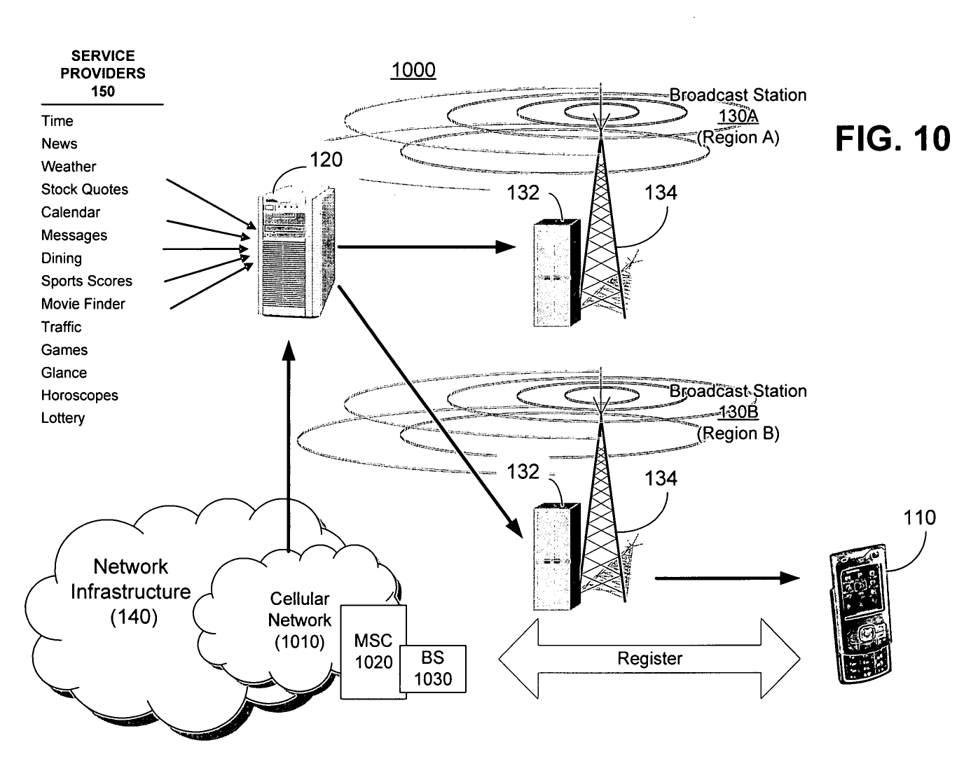

FIG. 10 is a block diagram of an exemplary operational environment in accordance with another embodiment. The operational environment 1000 is generally the same as the operational environment 100 of FIG. 1, except that location-type information relating to the user device 110 is transmitted from a communications service provider or communications network, such as a cellular network, to the broadcast system or its components.

For example, as shown in FIG. 10, the network infrastructure 140 includes among other network components a cellular network 1010 having a mobile service center(s) (MSC) 1020 and base station(s) (or access point) 1030. In this example, the user device 110 may be a mobile or cellular phone capable of accessing and communicating through the cellular network 1010. Whenever the user device 110 registers with the network 1010, the network 1010 maintains information pertaining to the location of the user device 110 such as to route calls, etc. As the user device 110 moves to a new location(s), the network 1010 likewise updates the location information. This may occur for example when the user device 110 is handed off from one base station to another base station. The location of the user device 110 may be maintained by the MSC 1020.

Since the network 1010 maintains location information for the user device 100, the network 1010 or its components may be configured to transmit location-type information of the user device 110 to the broadcast system or its components. The transmission of such information may be conditioned upon some triggering event or other factor. For example, the network 1010 or its components (e.g., base station 1030 or MSC 1020) may be configured to transmit location-type information of the user device 110 to the broadcast system or its components (e.g., server 120 or 132): (i) in response to the initial registration of the user device 110 with the network 1010, (ii) when the location of the user device 110 changes (e.g., hand off to a new base station occurs), (iii) at predefined time and/or date, (iv) at the user's request through the user device 110 (e.g., a request is initiated and sent from the user device to the network 1010), (iv) at the broadcast system's request (e.g., a request is initiated and sent from server 120 of the broadcast system) and so forth. The above provides a few examples of conditions upon which the network 1010 may be configured to transmit location-type information of one or more user devices of one or more users to the broadcast system or its components. The network 1010 or its components may be configured to transmit such information based on other conditions.

Although the above describes the network 1010 as a cellular network, other types of communications networks may be configured to transmit location-type information, such as those wireless networks which inherently track the location of a user's device or may be configured to track the location of the a user's device. For example, as described above, a communications network such as a W-LAN may be configured to transmit location-type information, such as location of access point (e.g., hot spots) nearest or accessed by the user device.

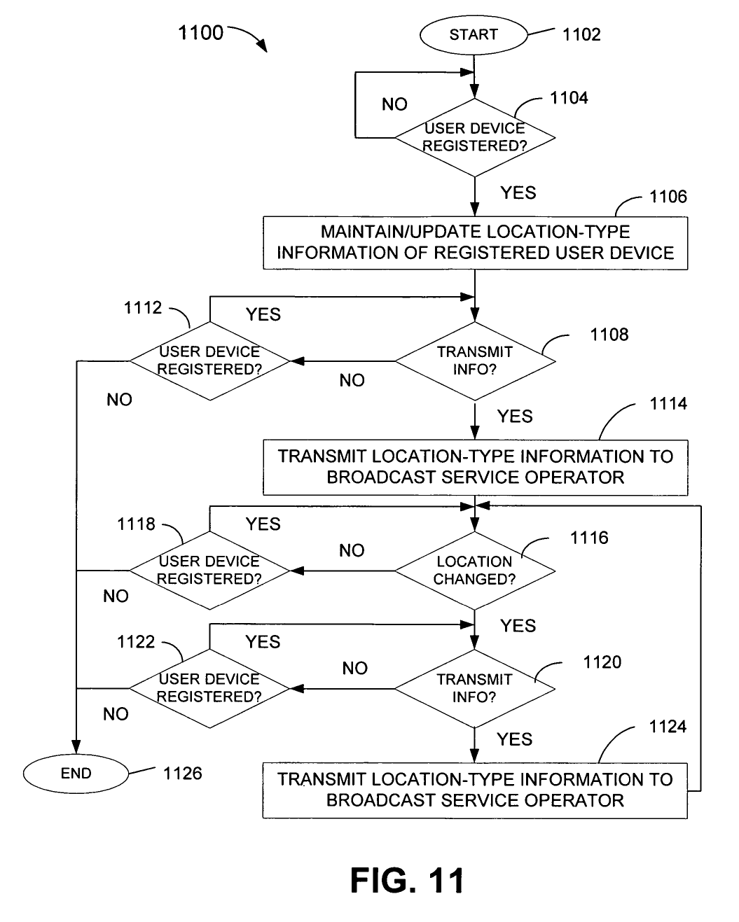

FIG. 11 is a flow diagram of an exemplary process 1100 implemented by a communications network system or its components in accordance with an embodiment. By way of example, the process 1100 will be described with reference to the MSC 1020 of the network 1010 and the user device 110 of FIG. 10. Other network components may also be configured to perform the operations of the process 1100.

The process 1100 begins at step 1102, which may involve initialization of system components of the MSC 1020. At step 1104, the MSC 1020 determines whether the user device 110 has or is registered or is registering with the network. If not, the MSC 1020 continues to check at step 1104. Otherwise, if the user device 110 is or has registered or is registering, then the MSC 1020 maintains (as well as may subsequently update) location-type information (e.g., position or location) of the user device 1106.

At step 1108, the MSC 1020 determines whether to transmit the location-type information of the user device 110 to the broadcast system or its components. This determination may be based on a triggering event or condition or other factor, such as those examples described above (e.g., at a predefined time or date, etc.). For instance, the network may be constantly aware of the location of the user and the triggering event/condition may be used, if desired, only to transmit the information. If not, at step 1112, the MSC 1020 determines whether the user device 110 is still registered with the network. If the user device 110 is still registered, then the process 1100 proceeds back to step 1108. Otherwise, if the user device 110 is no longer registered, then the process 1100 terminates as to the particular user device 110 at step 1126.

If the MSC 1020 determines that the location-type information is to be transmitted, then the information is transmitted to the broadcast system or its components (e.g., server 120 or 132) at step 1114. For instance, the communication network can generate the location information message, and transmit the information to the appropriate destination. At step 1116, the MSC 1020 determines whether the location of the user device 110 has changed. If not, at step 1118, the MSC 1020 determines whether the user device 110 is still registered with the network. If the user device 110 is still registered, then the process 1100 proceeds back to step 1116. Otherwise, if the user device 110 is no longer registered, then the process 1100 terminates as to the particular user device 110 at step 1126.

If the location has changed, the MSC 1020 determines whether to transmit the location-type information of the user device 110 to the broadcast system or its components at step 1120. This determination may be based on a triggering event or condition or other factor, such as those examples described above (e.g., at a predefined time or date, etc.). If not, at step 1122, the MSC 1020 determines whether the user device 110 is still registered with the network. If the user device 110 is still registered, then the process 1100 proceeds back to step 1120. Otherwise, if the user device 110 is no longer registered, then the process 1100 terminates as to the particular user device 110 at step 1126.

If the MSC 1020 determines that the location-type information is to be transmitted at step 1120, then the information is transmitted to the broadcast system or its components (e.g., server 120 or 132) at step 1124. The process 1100 thereafter proceeds back to step 1116.

The above described process described with reference to FIG. 11 may be implemented or controlled by software including firmware through one or more processors or one or more hardwired or integrated circuits or a combination thereof. The software implementation may take the form of a tangible medium having computer executable code which when read and executed by one or more processors performs the processes described above and herein. This process is provided as an example. The process is not limited to the described operations or order of operations which can be modified to perform the various functions described herein, and may be performed by any suitable network component, as desired.

While various embodiments of the present invention have been described above, it should be understood that they have been presented by way of example only, and not in limitation. Accordingly, it will be apparent to persons skilled in the relevant art that various changes in form and detail can be made therein without departing from the spirit and scope of the invention. Thus, the breadth and scope of the present invention should not be limited by any of the above-described exemplary embodiments, but should be defined only in accordance with the following claims and their equivalents. Thus, other network types are within the scope of the present invention.

What is claimed is:

1. A method comprising:
transmitting information indicating at least a location of the user device; and
receiving a broadcast in a selected region from a plurality of broadcast regions in response to the transmitted information, the broadcast including personalized service for the user of the user device.

2. The method according to claim 1, wherein the broadcast is a FM radio broadcast or Digital Video Broadcasting-Handheld (DVB-H).

3. The method according to claim 1, wherein the personalized service is provided through Smart Personal Object Technology (SPOT) or Data Radio Channel (DARC) or System for Wireless Infotainment Forwarding and Teledistribution (SWIFT).

4. The method according to claim 1, wherein the personalized service comprises personal data targeted for the user.

5. The method according to claim 1, further comprising:
determining whether personalized service is available to the user device at a current location, wherein the information indicating at least a location of the user device is transmitted if personalized service is unavailable to the user device at the current location.

6. The method according to claim 5, wherein the determining comprising ascertaining whether the user device is registered to receive personalized service at the current location.

7. The method according to claim 5, wherein the determining comprising:
ascertaining whether personalized service is being received across one or more broadcast channels.

8. The method according to claim 1, further comprising:
transmitting from the user device information for configuring the personalized service for the user.

9. The method according to claim 1, wherein the transmitting and the receiving are performed by the user device across different communication channels.

10. The method according to claim 1, further comprising:
providing access to the personalized service on the user device.

11. The method according to claim 1, further comprising obtaining a cell identifier of the nearest base station to the user device, wherein the information indicating at least a location of the user device comprises at least the obtained cell identifier.

12. The method according to claim 1, further comprising obtaining position of the user device through GPS, wherein the information indicating at least a location of the user device comprises at least the obtained position.

13. The method according to claim 1, wherein the information indicating at least a location of the user device is transmitted from another communications-enabled device of the user.

14. The method according to claim 13, wherein the user device is a Smart Personal Object Technology (SPOT) device and the another communications-enabled device is a mobile phone.

15. The method according to claim 1, wherein the information indicating at least a location of the user device is transmitted from the user device to the another communications-enabled device of the user using short range wireless communications, the another communications-enable device of the user then transmitting the information to a broadcast system which broadcasts personal service to the user.

16. The method according to claim 1, wherein the information indicating at least a location of the user device is generated and transmitted by a communications network.

17. The method according to claim 16, wherein the communications network generates and/or transmits the information indicating at least a location of the user device upon a triggering event or condition.

18. The method according to claim 1, wherein the communications network is a cellular network.

19. A method comprising:
receiving information transmitted from a user device of a user indicating a location of the user device; and
controlling broadcasting of personalized service for the user at a selected region from a plurality of broadcast regions according to the received information.

20. The method according to claim 19, wherein the broadcast is FM radio broadcast or Digital Video Broadcasting-Handheld (DVB-H).

21. The method according to claim 19, wherein the personalized service is provided through Smart Personal Object Technology (SPOT) or Data Radio Channel (DARC) or System for Wireless Infotainment Forwarding and Teledistribution (SWIFT).

22. The method according to claim 19, further comprising:
receiving information transmitted from the user device for configuring the personalized service for the user,
wherein the personalized service broadcasted are configured according to the received information for configuring the personalized service for the user.

23. The method according to claim 19, further comprising:
selecting a broadcast station from a plurality of broadcast stations according to the received information; and
routing user data to the selected broadcast station for broadcast of personalized service to the user.

24. The method according to claim 19, wherein the information transmitted from the user device for indicating the location of the user device is transmitted through another communications-enabled device of the user.

25. The method according to claim 24, wherein the user device is a Smart Personal Object Technology (SPOT) device and the another communications-enabled device is a mobile phone.

26. An apparatus comprising:
one or more communication interfaces for transmitting information indicating at least a location of the user device and for receiving a broadcast in a selected region from a plurality of broadcast regions in response to the transmitted information, the broadcast including personalized service for the user.

27. A system comprising:
a communication interface for receiving information transmitted from a user device of a user indicating a location of the user device; and
one or more processors for controlling broadcasting of personalized service for the user at a selected region from a plurality of broadcast regions according to the received information.

28. A computer readable medium having computer executable code which when executed by a processor performs the following method:
transmitting information indicating at least a location of the user device; and
receiving a broadcast in a selected region from a plurality of broadcast regions in response to the transmitted information, the broadcast including personalized service for the user of the user device.

29. A computer readable medium having computer executable code which when executed by a processor performs the following method:
receiving information transmitted from a user device of a user indicating a location of the user device; and
controlling broadcasting of personalized service for the user at a selected region from a plurality of broadcast regions according to the received information.

30. A method comprising:
obtaining information indicating a location of a user device of a user, the information corresponding to a location of a network component of a communications network through which the user device conducts communications;
transmitting the information to a broadcast system so that personalized service is broadcasted in a selected region from a plurality of broadcast regions to the user based on the information.

31. The method according to claim 30, wherein the transmitting operation is performed by the user device.

32. The method according to claim 30, wherein the transmitting operation is performed by a communications network.

33. The method according to claim 30, wherein the network component comprises a base station or access point.

34. An apparatus comprising:
a processor for:
obtaining information indicating a location of a user device of a user, the information corresponding to a location of a network component of a communications network through which the user device conducts communications; and
controlling transmission of the information to a broadcast system so that personalized service is broadcasted in a selected region from a plurality of broadcast regions to the user based on the information.

35. The apparatus according to claim 34, wherein the apparatus is the user device.

36. The apparatus according to claim 34, wherein the apparatus is a component of the communications network.

37. A computer readable medium having computer executable code which when executed by a processor performs the following method:
obtaining information indicating a location of a user device of a user, the information corresponding to a location of a network component of a communications network through which the user device conducts communications;
controlling transmission of the information to a broadcast system so that personalized service is broadcasted in a selected region from a plurality of broadcast regions to the user based on the information.

38. An apparatus comprising:
means for transmitting information indicating at least a location of the user device; and
means for receiving a broadcast in a selected region from a plurality of broadcast regions in response to the transmitted information, the broadcast including personalized service for the user.

39. The apparatus according to claim 38, wherein the information indicating at least a location of the user device is transmitted from another communications-enabled device of the user.
